(19) United States
(12) Patent Application Publication
(10) Pub. No.: US 2026/0364867 A1
(43) Pub. Date: Nov. 19, 2026

(54) INJECTION MOLDING MACHINE AND INJECTION MOLDING METHOD

(71) Applicant: SUMITOMO HEAVY INDUSTRIES, LTD., Tokyo (JP)

(72) Inventor: Naofumi SUKEDA, Chiba-shi (JP)

(21) Appl. No.: 19/634,030

(22) Filed: Mar. 30, 2026

(30) Foreign Application Priority Data
May 14, 2025 (JP) 2025-081473

(51) Int. Cl. B29C 45/76

(52) U.S. Cl. CPC B29C 45/7653; B29C 2945/7616; B29C 2945/7629; B29C 2945/76505; B29C 2945/76702; B29C 2945/76936

(57) ABSTRACT

An injection molding machine includes a control device that controls a mold clamping unit that clamps a mold, in which the control device is configured to determine, based on an actual result in a case where a set mold clamping force is temporarily changed from a first mold clamping force to a second mold clamping force that is smaller than the first mold clamping force, whether the second mold clamping force is appropriate, receive an input indicating whether a quality defect of a molded product is present, and determine, based on a determination result and an input result, whether to change the set mold clamping force from the first mold clamping force to the second mold clamping force, or temporarily change the set mold clamping force to a third mold clamping force that is smaller than the second mold clamping force.

### CROSS-REFERENCE TO RELATED APPLICATIONS

This application claims priority to Japanese Patent Application No. 2025-081473, filed on May 14, 2025, which is incorporated by reference herein in its entirety.

### BACKGROUND

### Technical Field

A certain embodiment of the present invention relates to an injection molding machine and an injection molding method.

### Description of Related Art

The related art discloses that a molding condition item to be adjusted, such as a mold clamping force, an adjustment range, and an adjustment step width are determined, and condition setting is automatically executed. The related art discloses that a configuration is adopted in which it is possible to input that a molded product having a desired quality is obtained in test molding. The related art discloses that a screen for inquiring whether to end molding navigation is displayed on a display screen, and in a case where a predetermined button on the inquiry screen is pressed, the molding navigation is ended.

### SUMMARY

One or more embodiments provide an injection molding machine including a control device that controls a mold clamping unit that clamps a mold, in which the control device is configured to determine, based on an actual result obtained in a case where a set mold clamping force of the mold is temporarily changed from a first mold clamping force to a second mold clamping force that is smaller than the first mold clamping force, whether the second mold clamping force is appropriate, receive an input indicating whether a quality defect of a molded product molded in a case where the set mold clamping force is temporarily changed to the second mold clamping force is present, and determine, based on a determination result and an input result, whether to change the set mold clamping force from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

One or more embodiments provide an injection molding method including causing a control device that controls a mold clamping unit that clamps a mold to determine, based on an actual result obtained in a case where a set mold clamping force of the mold is temporarily changed from a first mold clamping force to a second mold clamping force that is smaller than the first mold clamping force, whether the second mold clamping force is appropriate, receive an input indicating whether a quality defect of a molded product molded in a case where the set mold clamping force is temporarily changed to the second mold clamping force is present, and determine, based on a determination result and an input result, whether to change the set mold clamping force from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

One or more embodiments provide an injection molding machine including a control device that controls a mold clamping unit that clamps a mold, in which the control device is configured to determine, based on a change over time in the mold clamping force when a set mold clamping force of the mold is temporarily changed from a first mold clamping force to a second mold clamping force that is smaller than the first mold clamping force, whether the second mold clamping force is appropriate, and determine, based on a determination result, whether to change the set mold clamping force from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

### BRIEF DESCRIPTION OF THE DRAWINGS

FIG. 1 is a diagram showing an example of a configuration of an injection molding machine, according to the present embodiment.

FIG. 2A is a graph showing a relationship between a change over time in injection pressure and a change over time in mold clamping force. FIG. 2B is a table in which characteristics of three types of mold clamping force waveforms in FIG. 2A are listed.

FIG. 3 is a diagram showing an example of a hardware configuration of a control device that constitutes the injection molding machine in FIG. 1.

FIG. 4 is a diagram showing an example of a functional configuration of a controller of the control device.

FIG. 5 is a flowchart showing an example of a process flow in the control device.

FIG. 6 is a diagram showing a specific example of a screen displayed on a display of the injection molding machine.

FIGS. 7A and 7B are diagrams showing specific examples of a screen displayed on the display of the injection molding machine.

### DETAILED DESCRIPTION

The related arts support the adjustment of molding conditions for enabling the molding of a non-defective product. However, even in a state where a non-defective product can be molded, it is preferable that the mold clamping force of the mold is small. This is because, when the mold clamping force is excessive, not only molding defects such as short shots due to poor gas escape, but also serious issues such as damage to the mold may occur. However, when the mold clamping force is insufficient, a gap is likely to occur in the mold, and thus molding defects such as burrs are likely to occur.

For this reason, even in a state where a non-defective product can be molded, it is desirable to set the mold clamping force as small as possible within a range where molding defects do not occur.

According to the present invention, it is possible to support the setting of the mold clamping force to be as small as possible within a range where molding defects do not occur even in a state where a non-defective product can be molded.

Here, the control device may be configured to determine not to change the set mold clamping force from the first mold clamping force, in a case where the input result indicates that the quality defect is present.

In addition, the control device may be configured to determine to change the set mold clamping force from the first mold clamping force to the second mold clamping force, the mold clamping force between the first mold clamping force and the second mold clamping force, or the mold clamping force close to the second mold clamping force, in a case where the determination result indicates that the second mold clamping force is appropriate and the input result indicates that the quality defect is not present.

In addition, the control device may be configured to determine to temporarily change the set mold clamping force from the second mold clamping force to the third mold clamping force that is smaller than the second mold clamping force, in a case where the determination result indicates that the second mold clamping force is not appropriate and the input result indicates that the quality defect is not present.

One or more embodiments provide a non-transitory computer readable storage medium storing a program causing a control device that controls a mold clamping unit that clamps a mold to execute a control process, the control process including determining, based on a change over time in the mold clamping force when a set mold clamping force of the mold is temporarily changed from a first mold clamping force to a second mold clamping force that is smaller than the first mold clamping force, whether the second mold clamping force is appropriate, and determining, based on a determination result, whether to change the set mold clamping force from the first mold clamping force to the second mold clamping force, a mold clamping force between the first mold clamping force and the second mold clamping force, or a mold clamping force close to the second mold clamping force, or temporarily changing the set mold clamping force to a third mold clamping force that is smaller than the second mold clamping force.

Here, the control device may be configured to determine that the second mold clamping force is appropriate, in a case where, as the change over time in the mold clamping force, the mold clamping force temporarily increases and then returns to an original mold clamping force.

In addition, the control device may be configured to determine that the second mold clamping force is insufficient and is not appropriate, in a case where, as the change over time in the mold clamping force, the mold clamping force increases and then does not return to an original mold clamping force.

In addition, the control device may be configured to determine that the second mold clamping force is excessive and is not appropriate, in a case where, as the change over time in the mold clamping force, the mold clamping force is constant.

One or more embodiments provide an injection molding method including causing a control device that controls a mold clamping unit that clamps a mold to determine, based on a change over time in the mold clamping force when a set mold clamping force of the mold is temporarily changed from a first mold clamping force to a second mold clamping force that is smaller than the first mold clamping force, whether the second mold clamping force is appropriate, and determine, based on a determination result, whether to change the set mold clamping force from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

One or more embodiments provide a non-transitory computer readable storage medium storing a program causing a control device that controls a mold clamping unit that clamps a mold to execute a control process, the control process including determining, based on a change over time in the mold clamping force when a set mold clamping force of the mold is temporarily changed from a first mold clamping force to a second mold clamping force that is smaller than the first mold clamping force, whether the second mold clamping force is appropriate, and changing, based on a determination result, the set mold clamping force from the first mold clamping force to the second mold clamping force, a mold clamping force between the first mold clamping force and the second mold clamping force, or a mold clamping force close to the second mold clamping force, or determining whether to temporarily change the set mold clamping force to a third mold clamping force that is smaller than the second mold clamping force.

Hereinafter, embodiments of the present invention will be described in detail with reference to the accompanying drawings.

### Configuration of Injection Molding Machine 1

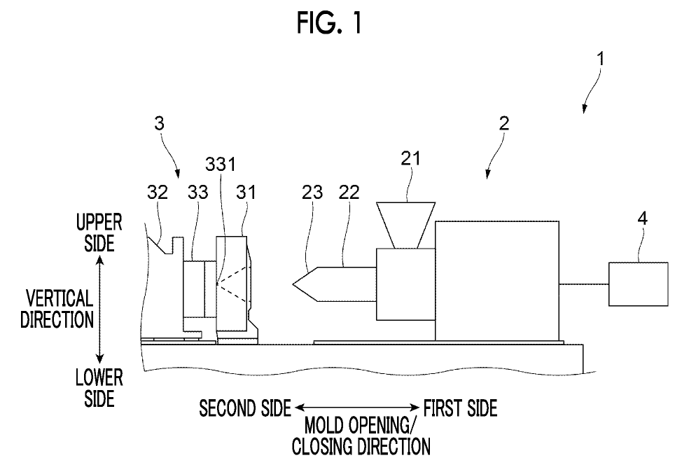

FIG. 1 is a diagram showing an example of a configuration of an injection molding machine 1 according to the present embodiment.

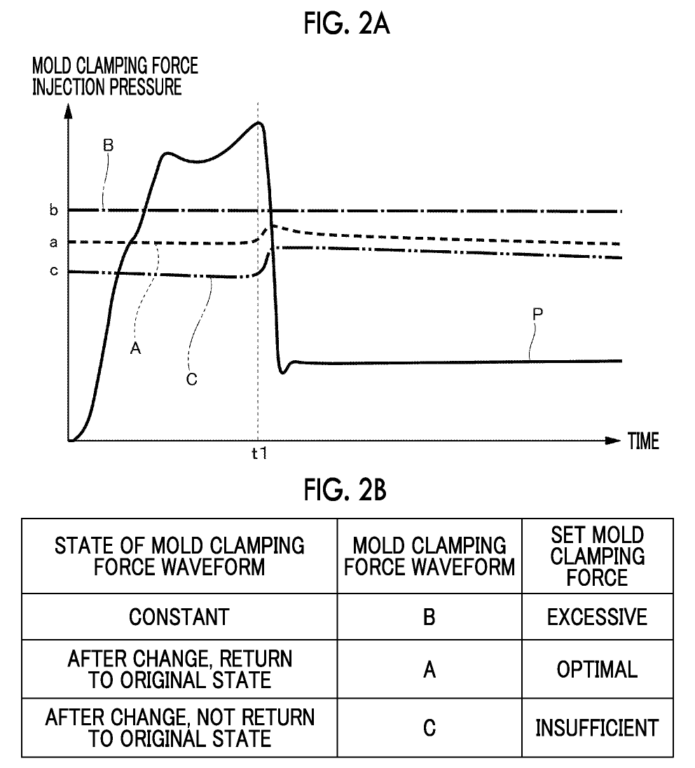

FIG. 2A is a graph showing a relationship between a change over time in injection pressure and a change over time in mold clamping force. FIG. 2B is a table in which characteristics of three types of mold clamping force waveforms in FIG. 2A are listed.

The injection molding machine 1 shown in FIG. 1 is a device that can manufacture a molded product, which is a product, by performing molding using a resin as a material. The injection molding machine 1 is configured to include an injection unit 2 that injects a resin, which is a material, into a mold 33 in a molten state, a mold clamping unit 3 that clamps the mold 33 so that the mold 33 is not opened, and a control device 4 that controls the entire injection molding machine 1.

Hereinafter, in the injection molding machine 1, a direction in which the mold 33 is opened and closed is referred to as a “mold opening/closing direction”. Further, a side of the injection unit 2 in the mold opening/closing direction with respect to the mold clamping unit 3 is referred to as a “first side”, and a side of the mold clamping unit 3 in the mold opening/closing direction with respect to the injection unit 2 is referred to as a “second side”. In addition, a height direction of the injection molding machine 1 is referred to as a “vertical direction”.

### Injection Unit 2

The injection unit 2 is a device including a hopper 21 that is an inlet for charging a pellet-shaped resin, which is a material, into an injection cylinder 22, the injection cylinder 22 that heats and melts the charged resin, and a nozzle 23 for injecting the resin in a molten state into the mold 33. The nozzle 23 is disposed at an end of the injection cylinder 22 on the second side in the mold opening/closing direction. When the injection unit 2 in the state shown in FIG. 1 moves toward the second side in the mold opening/closing direction, the nozzle 23 comes into contact with a nozzle touch 331 disposed at an inlet of a sprue of the mold 33. As a result, the injection unit 2 is in a state where the resin can be injected into the mold 33. The sprue refers to a flow path into which the resin flows.

### Mold Clamping Unit 3

The mold clamping unit 3 is a device that opens and closes the mold 33. The mold clamping unit 3 clamps the mold 33 with a predetermined mold clamping force such that the resin injected into the mold 33 does not push open the mold 33. The mold clamping force is controlled by a control device 4 described later. The mold 33 is attached to a stationary platen 31 and a movable platen 32. The mold 33 is opened and closed in the mold opening/closing direction in conjunction with a movement of the movable platen 32. That is, the mold 33 is opened by the movable platen 32 moving toward the second side in the mold opening/closing direction, and the mold 33 is closed by the movable platen 32 moving toward the first side in the mold opening/closing direction.

When the resin is injected in a state where the nozzle 23 is in contact with an inlet of the sprue of the mold 33, the injected resin flows through the sprue and flows into the mold 33. The mold 33 molds the resin that has flowed into the mold 33 by a mold opening/closing operation, and cools and solidifies the resin to complete a molded product. As described above, the mold opening/closing operation of the mold 33 is performed by the mold clamping unit 3.

### Control Device 4

The control device 4 is a device that controls the entire injection molding machine 1 including the control of the injection unit 2 and the mold clamping unit 3. For example, the control device 4 can control a value (hereinafter, referred to as a “set mold clamping force”) that is set in advance as a maximum pressure that the mold 33 should withstand when the mold clamping unit 3 clamps the mold 33.

For example, FIG. 2A shows waveforms (hereinafter, referred to as “mold clamping force waveforms”) A to C representing a relationship between time and a mold clamping force. In addition, FIG. 2B shows characteristics of each of the mold clamping force waveforms A to C. For example, the mold clamping force waveform A is a waveform of a mold clamping force formed by a mold clamping force at a mold clamping start being “a” and a change over time of the mold clamping force. In the mold clamping force waveform A, the mold clamping force fluctuates to increase at a timing t1 described later, and then returns to the original state.

In addition, the mold clamping force waveform B is a waveform of a mold clamping force formed by a mold clamping force at a mold clamping start being “b” larger than “a” and no change over time of the mold clamping force. In the mold clamping force waveform B, the mold clamping force is constant. In addition, the mold clamping force waveform C is a waveform of a mold clamping force formed by a mold clamping force at a mold clamping start being “c” smaller than “a” and a change over time of the mold clamping force. In the mold clamping force waveform C, the mold clamping force fluctuates to increase at the timing t1, and then does not return to the original state. In addition, FIG. 2A shows a waveform P representing a relationship between time and an injection pressure. The waveform P is a waveform formed by an injection pressure at a mold clamping start being 0 (zero) and a change over time of the injection pressure.

The timing t1 shown on a time axis of FIG. 2A is a timing at which the molten resin fills the mold 33. At the timing t1, the injection pressure is maximized, and a pressure at which the molten resin filled in the mold 33 tends to push and expand an inner wall of the mold 33 is maximized. Here, in a case where the pressure at which the molten resin tends to push and expand the inner wall of the mold 33 is increased, there is a concern that a gap is generated in the mold 33 and the molten resin leaks. Therefore, at the timing t1, a mold clamping force for suppressing the pressure at which the molten resin tends to push and expand the mold 33 from the inside is required.

Regarding this point, in the mold clamping force waveform A, the mold clamping force is constant at “a” from the mold clamping start to the timing t1 at which the injection pressure is maximized, but the mold clamping force is increased with the timing t1 as a starting point, and then returns to “a” in a case where the injection pressure is decreased. That is, in a case where the injection pressure of the injection unit 2 is maximized at the timing t1, the mold clamping force is increased such that the pressure at which the molten resin tends to push and expand the mold 33 from the inside can be suppressed. Thereafter, in a case where the injection pressure is decreased, the mold clamping force is also decreased and returns to “a”. In a case where the waveform such as the mold clamping force waveform A is shown, it can be said that the set mold clamping force is optimal without excess or deficiency. In a case where the set mold clamping force is optimal, contamination, deformation, damage, and the like of the mold 33 are reduced, so that an extension of a maintenance cycle can be expected.

In addition, in the mold clamping force waveform B, the mold clamping force is constant at “b”. Since “b” is the mold clamping force that can suppress the pressure at which the molten resin tends to push and expand the mold 33 from the inside, “b” is constant regardless of the change in the injection pressure of the injection unit 2. In a case where the waveform such as the mold clamping force waveform B is shown, it can be said that the set mold clamping force is excessive. In a case where the mold clamping force is excessive, a gap is less likely to be generated in a parting surface of the mold 33, so that the leakage of the molten resin is suppressed, but the following issues may occur.

That is, in a case where the mold clamping force is excessive, the parting surface of the mold 33 is strongly pressed, and there is a concern that a gas vent, which is a fine gap for degassing, is crushed. In a case where the gas vent is crushed, gas or air generated from the molten resin is not sufficiently discharged and is trapped in a cavity. That is, molding defects such as a short shot, a burn mark, a void, and a sink mark due to the poor gas escape are likely to occur. In addition, the excessive mold clamping force may give excessive stress to the mold 33, cause abrasion, cracks, and deformation, and shorten the service life of the mold 33. Further, an excessive load is applied to drive components (for example, a toggle mechanism, a hydraulic system, and the like) of the injection molding machine 1 due to a greater force than necessary being applied, and the risk of failure is increased.

In addition, in the mold clamping force waveform C, the mold clamping force is constant at “c” from the start of the mold clamping to the timing t1 at which the injection pressure is at its maximum, but the mold clamping force increases from the timing t1 as a starting point, and then the mold clamping force does not return to the original “c” even when the injection pressure decreases. That is, when the injection pressure of the injection unit 2 is at its maximum at the timing t1, the mold clamping force is also increased so that the pressure at which the molten resin tends to push and spread the mold 33 from the inside can be suppressed. Thereafter, even when the injection pressure decreases, the mold clamping force is maintained at a large value without returning to the original “c”. This is because the mold clamping force is originally insufficient at “c” which is the set mold clamping force, and thus the parting surface of the mold 33 is not sufficiently closely attached, a gap is likely to be generated, and there is a concern that the molten resin leaks. When the molten resin leaks, molding defects such as burrs are likely to occur, and the appearance quality and the dimensional accuracy are deteriorated. That is, in a case where a waveform such as the mold clamping force waveform C is shown, it can be said that the set mold clamping force is insufficient.

The control device 4 receives an operation of inputting various types of information. For example, the control device 4 receives an operation of inputting a value of the set mold clamping force. In this case, the control device 4 sets the received value as the set mold clamping force.

In addition, the control device 4 receives an operation of selecting whether to optimize the set mold clamping force. In this case, the control device 4 determines whether the set mold clamping force is appropriate, and determines whether to change the set mold clamping force based on a determination result. Specifically, the control device 4 determines whether the second mold clamping force is appropriate as the set mold clamping force based on a change over time in the mold clamping force in a case where the set mold clamping force is temporarily changed from the first mold clamping force to the second mold clamping force smaller than the first mold clamping force. Here, the term “appropriate” includes, in addition to a case where the set mold clamping force is optimal, cases where the set mold clamping force cannot be said to be inappropriate, such as a case where the set mold clamping force is not optimal but is not excessive, or a case where the set mold clamping force is not optimal but is not insufficient. Hereinafter, a setting in which the control device 4 performs a determination process for optimizing the set mold clamping force is referred to as an “optimal mold clamping force determination mode”.

In a case where the optimal mold clamping force determination mode is selected, the control device 4 receives an operation of setting a difference between the value of the first mold clamping force and the value of the second mold clamping force (hereinafter, referred to as a “reduced mold clamping force”). Then, the control device 4 determines whether the second mold clamping force smaller than the first mold clamping force by the reduced mold clamping force is appropriate as the set mold clamping force. The operation of selecting the optimal mold clamping force determination mode and the operation of setting the reduced mold clamping force are performed by an input operation on a predetermined operation screen.

For example, in the example of FIGS. 2A and 2B, the control device 4 determines whether the second mold clamping force is appropriate based on a change over time in the mold clamping force in a case where the set mold clamping force is temporarily changed from the first mold clamping force in which the mold clamping force at the mold clamping start is larger than “b” to the second mold clamping force in which the mold clamping force at the mold clamping start is “b”. In this case, since the mold clamping force changes to the mold clamping force waveform B of FIGS. 2A and 2B, the control device 4 determines that the second mold clamping force is excessive.

In addition, for example, in the example of FIGS. 2A and 2B, the control device 4 determines whether the second mold clamping force is appropriate based on a change over time in the mold clamping force in a case where the set mold clamping force is temporarily changed from the first mold clamping force in which the mold clamping force at the mold clamping start is “b” to the second mold clamping force in which the mold clamping force at the mold clamping start is “a”. In this case, since the mold clamping force changes to the mold clamping force waveform A of FIGS. 2A and 2B, the control device 4 determines that the second mold clamping force is optimal.

In addition, for example, in the example of FIGS. 2A and 2B, the control device 4 determines whether the second mold clamping force is appropriate based on a change over time in the mold clamping force in a case where the set mold clamping force is temporarily changed from the first mold clamping force in which the mold clamping force at the mold clamping start is “a” to the second mold clamping force in which the mold clamping force at the mold clamping start is “c”. In this case, since the mold clamping force changes to the mold clamping force waveform C of FIGS. 2A and 2B, the control device 4 determines that the second mold clamping force is insufficient.

The control device 4 determines whether to change the set mold clamping force to the second mold clamping force, a mold clamping force between the first mold clamping force and the second mold clamping force, or a mold clamping force close to the second mold clamping force, based on a result of determining whether it is appropriate to change the set mold clamping force from the first mold clamping force to the second mold clamping force. Here, the “mold clamping force close to the second mold clamping force” may include not only a value near the second mold clamping force but also the first mold clamping force set in the past, including the previous time, or the mold clamping force between the first mold clamping force and the second mold clamping force. For example, in a case where the set mold clamping force is changed to the second mold clamping force in which the mold clamping force at the mold clamping start is “c”, the mold clamping force is insufficient, and thus the control device 4 determines not to change the set mold clamping force. On the other hand, in a case where the set mold clamping force is changed to the second mold clamping force in which the mold clamping force at the mold clamping start is “a”, the mold clamping force is optimal, and thus the control device 4 determines to change the set mold clamping force.

In addition, the control device 4 can receive an input as to whether a quality defect of the molded product molded in a case where the set mold clamping force is temporarily changed from the first mold clamping force to the second mold clamping force is present. In this case, the control device 4 may determine whether to change the set mold clamping force to the second mold clamping force, the mold clamping force between the first mold clamping force and the second mold clamping force, or the mold clamping force close to the second mold clamping force, based on a determination result as to whether it is appropriate to temporarily change the set mold clamping force from the first mold clamping force to the second mold clamping force and on an input result as to whether a quality defect of the molded product is present.

For example, in a case where the input result as to whether a quality defect of the molded product is present indicates that a quality defect of the molded product is present, the control device 4 determines not to change the set mold clamping force from the first mold clamping force. On the other hand, in a case where it is determined that it is appropriate to change the set mold clamping force from the first mold clamping force to the second mold clamping force and the input result as to whether a quality defect of the molded product is present indicates that a quality defect is not present, the control device 4 determines to change the set mold clamping force to the second mold clamping force, the mold clamping force between the first mold clamping force and the second mold clamping force, or the mold clamping force close to the second mold clamping force.

In addition, in a case where it is determined that it is not appropriate to change the set mold clamping force from the first mold clamping force to the second mold clamping force and the input result as to whether a quality defect of the molded product is present indicates that a quality defect is not present, the control device 4 can determine as follows. That is, the control device 4 can determine to temporarily change the set mold clamping force from the second mold clamping force to the third mold clamping force smaller than the second mold clamping force. The configuration of the control device 4 and the details of the process flow will be described later.

### Hardware Configuration of Control Device 4

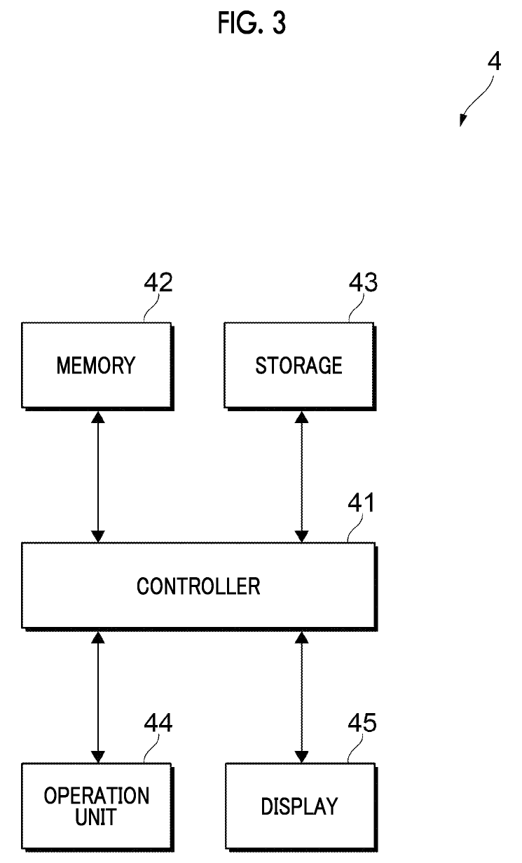

FIG. 3 is a diagram showing an example of a hardware configuration of the control device 4 constituting the injection molding machine 1 of FIG. 1.

The control device 4 includes a controller 41, a memory 42, a storage 43, an operation unit 44, and a display 45. Each of these parts is connected by a data bus, an address bus, a Peripheral Component Interconnect (PCI) bus, or the like.

The controller 41 is a processor that controls the functions of the control device 4 through the execution of various software such as an OS (basic software) and application software (applied software). In the present embodiment, various processes are executed by any computer. Any computer may be realized as a processor that is hardware, a program that is software, or a combination thereof. Any computer may be a general-purpose computer, a computer for a specific purpose, a workstation, or another system that can execute each processing.

The processor is configured to execute various processes in cooperation with a program. The processor can function as each unit or each means in the present embodiment. An execution order of the processes by the processor is not limited to the order described in the present embodiment, and can be changed as necessary.

The processor can be constituted by one or a plurality of pieces of hardware. The type of hardware constituting the processor is not limited to a specific type. For example, the processor may be a central processing unit (CPU), a microprocessing unit (MPU), a programmable logic device such as a field-programmable gate array (FPGA), a dedicated circuit for executing specific processing such as an application-specific integrated circuit (ASIC), a graphics processing unit (GPU), or hardware such as a neural processing unit (NPU).

The processor is not limited to a combination of a plurality of pieces of hardware of the same type, and can also be constituted by a combination of a plurality of pieces of hardware of different types. In a case where the plurality of pieces of hardware are configured to execute one or a plurality of processes of a certain processor, the plurality of pieces of hardware may exist in devices that are physically separate from each other, or may exist in the same device. The hardware is configured by an electric circuit (circuitry) or the like in which circuit elements such as semiconductor devices are combined.

In any of the embodiments, an execution order of various processes by the processor is not limited to an order described in each embodiment, and can be changed as necessary. The program may be software such as microcode in addition to firmware. The program may be, for example, a program module group. Each function constituting the program module group may be realized by a processor configured to execute each function. The program in each of the embodiments may be program codes or a plurality of code segments stored in one or a plurality of non-transitory computer-readable media (for example, a semiconductor memory, a magnetic or optical storage medium, or other storage).

The program may be divided and stored in a plurality of non-transitory computer-readable media existing in devices that are physically separate from each other. The program code or the plurality of code segments can represent any combination of a procedure, a function, a subprogram, a routine, a subroutine, a module, a software package, a class, a command, a data structure, or a program statement. The program code or the plurality of code segments may be connected to other code segments or hardware circuits by transmitting and receiving information, data, an argument, a parameter, or a memory content.

The memory 42 is a storage area that stores various software, data used for the execution of the software, and the like, and is used as a work area for calculation. The memory 42 includes, for example, a random-access memory (RAM), or the like.

The storage 43 is a storage area that stores input data for various software, output data from various software, and the like. The storage 43 includes, for example, a hard disk drive (HDD), a solid-state drive (SSD), a semiconductor memory, or the like used for storing a program, various setting data, or the like. The storage 43 is provided with a database for storing various types of information. Examples of the database provided in the storage 43 include a database in which a predetermined set value is stored.

The operation unit 44 is constituted by, for example, a keyboard, a mouse, a mechanical button, and a switch, and receives an input operation. The operation unit 44 also includes a touch sensor that constitutes a touch panel integrally with the display 45. The display 45 includes, for example, a liquid-crystal display or an organic electroluminescence (EL) display used for displaying information, and displays data such as an image or text. A user interface or the like is displayed on the display 45.

### Functional Configuration of Controller 41 of Control Device 4

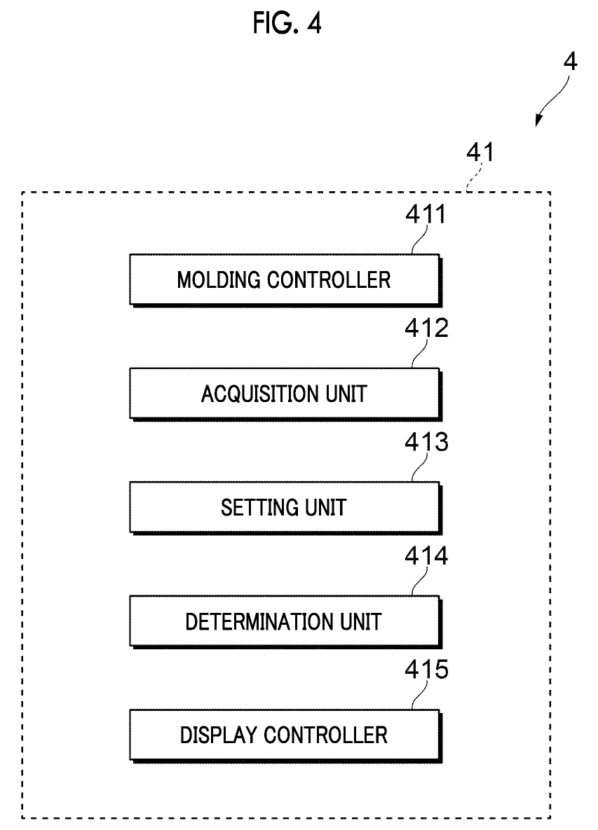

FIG. 4 is a diagram showing an example of a functional configuration of the controller 41 of the control device 4.

In the controller 41 of the control device 4, a molding controller 411 that controls the injection molding, an acquisition unit 412 that acquires various types of information, and a setting unit 413 that performs various types of settings function. In addition, in the controller 41, a determination unit 414 that performs various types of determination and a display controller 415 that performs control for displaying various types of information are provided.

The molding controller 411 controls the injection molding by controlling the operation of each of the injection unit 2 and the mold clamping unit 3.

The acquisition unit 412 acquires, for example, input information input to an operation screen displayed on the display 45 (see FIG. 3). Examples of the input information include a set mold clamping force value, information input to select the optimal mold clamping force determination mode, and information input to set the reduced mold clamping force.

The setting unit 413 performs various types of settings based on the input information acquired by the acquisition unit 412. For example, the setting unit 413 sets the set mold clamping force. The setting of the set mold clamping force by the setting unit 413 includes a temporary setting and a permanent setting. In addition, the setting unit 413 sets the reduced mold clamping force.

The determination unit 414 determines whether the set mold clamping force is appropriate. Specifically, the determination unit 414 determines whether the second mold clamping force is appropriate as the set mold clamping force, based on a change over time in the mold clamping force when the set mold clamping force is temporarily changed from the first mold clamping force to the second mold clamping force. In this case, the change over time in the mold clamping force may be identified, for example, as a mold clamping force waveform illustrated in FIG. 2A, or may be identified as a value.

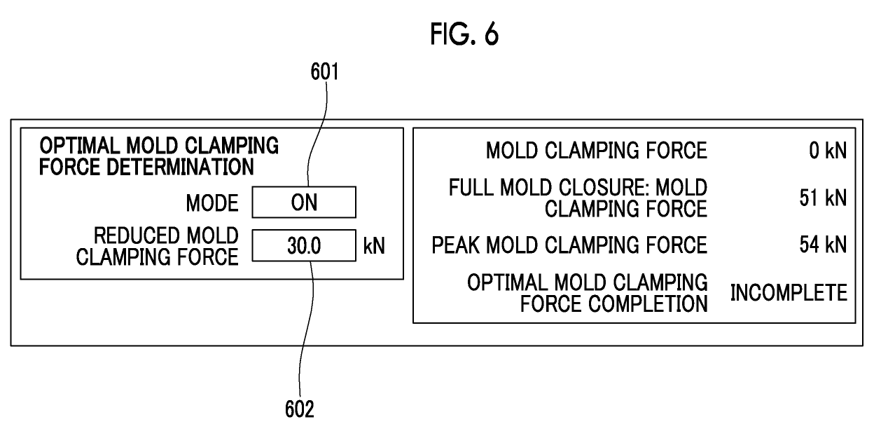

The display controller 415 performs control to display an operation screen on the display 45. The operation screen displayed on the display 45 includes an input field for inputting the value of the set mold clamping force, an input field for selecting the optimal mold clamping force determination mode, and an input field for setting the reduced mold clamping force. A specific example of the operation screen including the input field for selecting the optimal mold clamping force determination mode and the input field for setting the reduced mold clamping force will be described later with reference to FIG. 6.

In addition, the operation screen displayed on the display 45 includes a start button for starting the injection molding. The start button includes an automatic molding start button for operating the injection molding machine 1 in a fully automatic mode and a semi-automatic molding start button for operating the injection molding machine 1 in a semi-automatic mode. The “fully automatic mode” refers to a setting in which one cycle of the injection molding including the injection of the molten resin, the holding pressure, the cooling, the opening and closing of the mold 33, and the removal of the molded product is repeatedly executed automatically. The “semi-automatic mode” refers to a setting in which one cycle of the injection molding is automatically executed. Hereinafter, the automatic execution of one cycle of the injection molding by selecting the “semi-automatic mode” may be referred to as “semi-automatic molding”. In the “semi-automatic mode”, in a case where the semi-automatic molding is executed a plurality of times, an operator needs to press the semi-automatic molding start button each time.

### Process Flow of Control Device 4

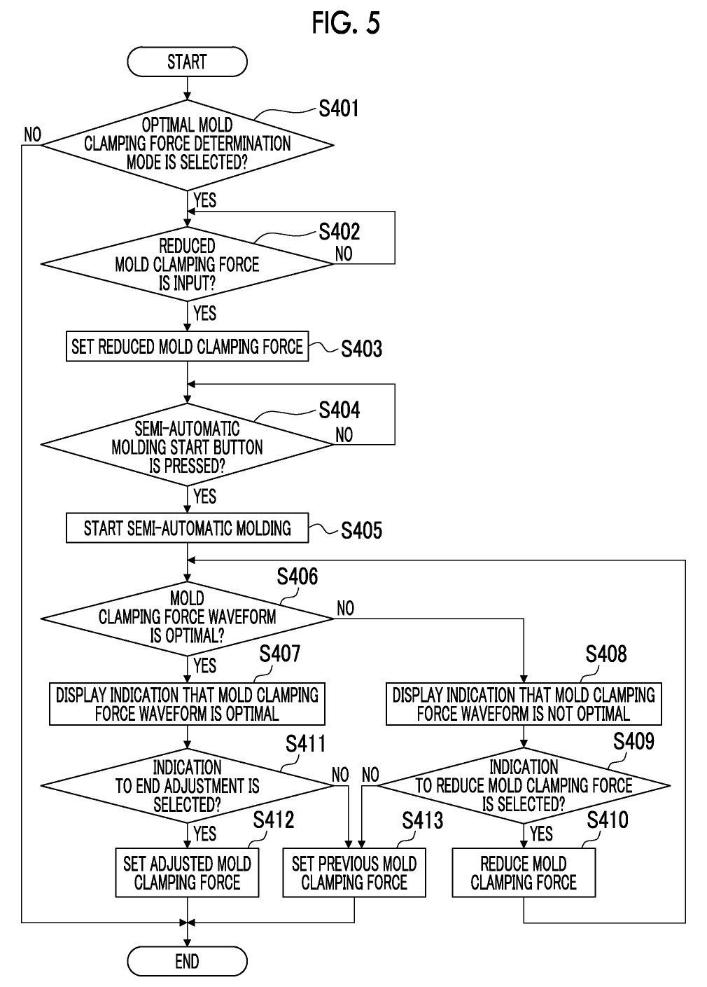

FIG. 5 is a flowchart showing an example of a process flow in the control device 4.

In a case where the optimal mold clamping force determination mode is selected (YES in step S401), the control device 4 proceeds to the determination processing of step S402. On the other hand, in a case where the optimal mold clamping force determination mode is not selected (NO in step S401), the control device 4 ends the process (END).

In a case where the reduced mold clamping force is input (YES in step S402), the control device 4 sets the reduced mold clamping force (step S403). On the other hand, in a case where the reduced mold clamping force is not input (NO in step S402), the control device 4 repeats the determination processing of step S402.

In a case where the semi-automatic molding start button is pressed (YES in step S404), the control device 4 temporarily changes the set mold clamping force from the first mold clamping force to the second mold clamping force to start the semi-automatic molding (step S405). On the other hand, in a case where the semi-automatic molding start button is not pressed (NO in step S404), the control device 4 repeats the determination processing of step S404.

The control device 4 determines whether the second mold clamping force is appropriate as the set mold clamping force based on the mold clamping force waveform showing the change over time in the mold clamping force in a case where the set mold clamping force is changed from the first mold clamping force to the second mold clamping force. Then, in a case where the mold clamping force waveform is optimal (YES in step S406), the control device 4 displays an indication that the mold clamping force waveform is optimal on the display 45 (refer to FIG. 3) (step S407), and proceeds to the determination processing of step S411. On the other hand, in a case where the mold clamping force waveform is not optimal (NO in step S406), the control device 4 displays an indication that the mold clamping force waveform is not optimal on the display 45 (step S408), and proceeds to the determination processing of step S409.

In a case where the indication to further reduce the mold clamping force is selected (YES in step S409) since a quality defect of the molded product is not present, the control device 4 further reduces the mold clamping force by the amount of the reduced mold clamping force (step S410), and returns to the determination processing of step S406. On the other hand, in a case where the indication to further reduce the mold clamping force is not selected (NO in step S409) since a quality defect of the molded product is present, the control device 4 sets the previous mold clamping force (step S413). That is, the control device 4 returns the set mold clamping force from the second mold clamping force to the first mold clamping force. As a result, the control device 4 ends the processing (END).

In addition, after the indication that the mold clamping force waveform is optimal is displayed in step S407, in a case where the indication to end the adjustment is selected (YES in step S411) since a quality defect of the molded product is not present, the control device 4 sets the adjusted mold clamping force (step S412), and ends the processing (END). That is, the control device 4 sets the temporarily set second mold clamping force as the permanent set mold clamping force.

On the other hand, after the indication that the mold clamping force waveform is optimal is displayed in step S407, in a case where the indication to end the adjustment is not selected (NO in step S411) since a quality defect of the molded product is present, the control device 4 sets the previous mold clamping force (step S413). That is, the control device 4 returns the set mold clamping force from the second mold clamping force to the first mold clamping force. As a result, the control device 4 ends the processing (END).

### Specific Example of Operation Screen

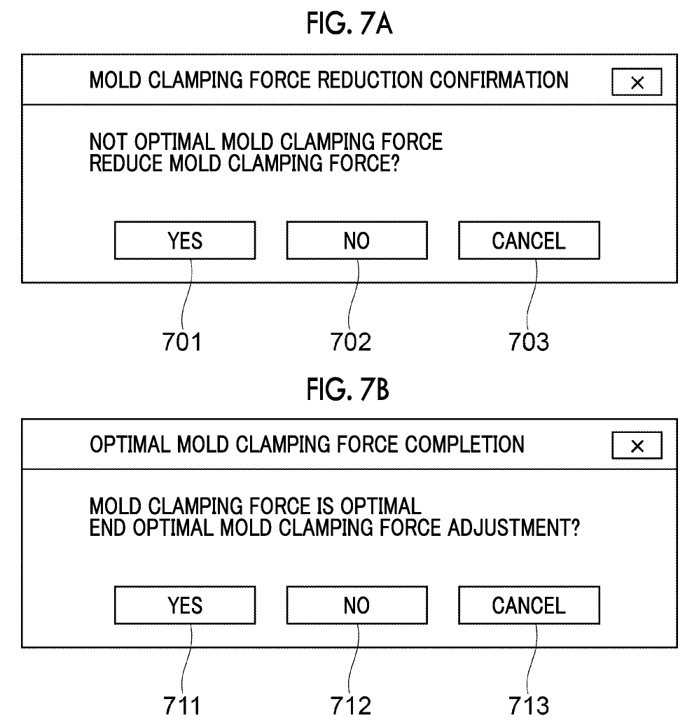

FIGS. 6, 7A, and 7B are diagrams showing specific examples of screens displayed on the display 45 (refer to FIG. 3) of the injection molding machine 1.

FIG. 6 shows a specific example of an operation screen displayed on the display 45 of the injection molding machine 1. On the operation screen shown in FIG. 6, a notation of “optimal mold clamping force determination”, an input field 601 for selecting the optimal mold clamping force determination mode, and an input field 602 for setting the reduced mold clamping force are displayed.

In FIG. 6, “ON” is displayed in the input field 601. This indicates that the optimal mold clamping force determination mode is selected. In addition, the text “30.0” is displayed in the input field 602. This indicates that the reduced mold clamping force is set to 30.0 kilonewtons (kN). In addition, on the operation screen shown in FIG. 6, the mold clamping force, the mold clamping force when the mold 33 (refer to FIG. 1) is completely closed (full mold closure: mold clamping force), the mold clamping force at the peak (peak mold clamping force), and whether the optimization of the set mold clamping force is completed (optimal mold clamping force completion) are displayed. In the example of FIG. 6, since the optimization of the set mold clamping force is not completed, “incomplete” is displayed.

FIGS. 7A and 7B show specific examples of a popup screen displayed on the display 45 of the injection molding machine 1. On the popup screen shown in FIG. 7A, a title “mold clamping force reduction confirmation” and a message including “not optimal mold clamping force” and “reduce mold clamping force?” are displayed. In addition, on the popup screen shown in FIG. 7A, a button 701 labeled “YES”, a button 702 labeled “NO”, and a button 703 labeled “CANCEL” are displayed.

In a case where the operator of the injection molding machine 1 (refer to FIG. 1) selects the indication to further reduce the mold clamping force because a quality defect of the molded product is not present, the operator presses the button 701 labeled “YES”. On the other hand, in a case where the operator does not select the indication to further reduce the mold clamping force because a quality defect of the molded product is present, the operator presses the button 702 labeled “NO”. In addition, in a case where the operator does not select whether to reduce the mold clamping force, the operator presses the button 703 labeled “CANCEL”.

On the popup screen shown in FIG. 7B, a title “optimal mold clamping force completion” and a message including “mold clamping force is optimal” and “end the optimal mold clamping force adjustment?” are displayed. In addition, on the popup screen shown in FIG. 7B, a button 711 labeled “YES”, a button 712 labeled “NO”, and a button 713 labeled “CANCEL” are displayed.

In a case where the operator of the injection molding machine 1 selects the indication to end the adjustment because a quality defect of the molded product is not present, the operator presses the button 711 labeled “YES”. On the other hand, in a case where the operator does not select the indication to end the adjustment because a quality defect of the molded product is present, the operator presses the button 712 labeled “NO”. In addition, in a case where the operator does not select whether to end the adjustment, the operator presses the button 713 labeled “CANCEL”. Since the operation screen shown in FIG. 6 and the popup screens shown in FIG. 7A and 7B are displayed, the operator can easily adjust the mold clamping force even in a case where the operator does not have sufficient knowledge or experience.

In summary, the injection molding machine 1 according to the present embodiment may have the following configuration and can be embodied in various manners.

That is, an injection molding machine 1 includes: a control device 4 that controls a mold clamping unit 3 for clamping a mold 33, in which the control device 4 is configured to determine, based on an actual result (for example, the above-mentioned mold clamping force waveform) obtained in a case where a set mold clamping force of the mold 33 is temporarily changed from a first mold clamping force to a second mold clamping force that is smaller than the first mold clamping force, whether the second mold clamping force is appropriate, receive an input indicating whether a quality defect of a molded product molded in a case where the set mold clamping force is temporarily changed to the second mold clamping force is present, and determine, based on a determination result as to whether the second mold clamping force is appropriate and on an input result as to whether a quality defect of the molded product is present, whether to change the set mold clamping force of the mold 33 from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

Accordingly, whether to change the set mold clamping force to the set mold clamping force after the temporary change is determined based on whether the set mold clamping force after the temporary change is appropriate and on whether a quality defect of the molded product is present due to the set mold clamping force. As a result, even in a state where a non-defective product can be molded, it is possible to support the setting of the mold clamping force to be as small as possible within a range where the molding defect does not occur.

Here, the control device 4 may be configured to determine not to change the set mold clamping force of the mold 33 from the first mold clamping force, in a case where the input result as to whether a quality defect of the molded product is present indicates that a quality defect of the molded product is present.

Accordingly, in a case where a quality defect of the molded product is present due to the set mold clamping force after the temporary change, the set mold clamping force is not changed to that set mold clamping force, and thus the risk of the molding defect can be reduced.

In addition, the control device 4 may be configured to determine to change the set mold clamping force of the mold 33 from the first mold clamping force to the second mold clamping force, a mold clamping force between the first mold clamping force and the second mold clamping force, or a mold clamping force close to the second mold clamping force, in a case where the determination result as to whether the second mold clamping force is appropriate indicates that the second mold clamping force is appropriate and the input result as to whether a quality defect of the molded product is present indicates that the quality defect is not present.

Accordingly, in a case where the set mold clamping force after the temporary change is appropriate and a quality defect of the molded product is not present due to the set mold clamping force, the set mold clamping force is changed to that set mold clamping force, and thus it is possible to support the setting of the mold clamping force to be as small as possible within a range where the molding defect does not occur even in a state where a non-defective product can be molded.

In addition, the control device 4 may be configured to determine to temporarily change the set mold clamping force of the mold 33 from the second mold clamping force to a third mold clamping force that is smaller than the second mold clamping force, in a case where the determination result as to whether the second mold clamping force is appropriate indicates that the second mold clamping force is not appropriate and the input result as to whether a quality defect of the molded product is present indicates that the quality defect is not present.

Accordingly, in a case where the set mold clamping force after the temporary change is not appropriate and a quality defect of the molded product is not present due to the set mold clamping force, the set mold clamping force is further changed to a smaller set mold clamping force, and thus it is possible to support the setting of the mold clamping force to be as small as possible within a range where the molding defect does not occur even in a state where a non-defective product can be molded.

In addition, an injection molding method according to the present embodiment may have the following configuration and can take various types of embodiments.

That is, the injection molding method according to the present embodiment is an injection molding method including causing a control device 4 that controls a mold clamping unit 3 for clamping a mold 33 to determine, based on an actual result in a case where a set mold clamping force of the mold 33 is temporarily changed from a first mold clamping force to a second mold clamping force that is smaller than the first mold clamping force, whether the second mold clamping force is appropriate, receive an input indicating whether a quality defect of a molded product molded in a case where the set mold clamping force of the mold 33 is temporarily changed to the second mold clamping force is present, and determine, based on a determination result as to whether the second mold clamping force is appropriate and on an input result as to whether a quality defect of the molded product is present, whether to change the set mold clamping force of the mold 33 from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

Accordingly, whether to change the set mold clamping force to the set mold clamping force after the temporary change is determined based on whether the set mold clamping force after the temporary change is appropriate and on whether a quality defect of the molded product is present due to the set mold clamping force. As a result, even in a state where a non-defective product can be molded, it is possible to support the setting of the mold clamping force to be as small as possible within a range where the molding defect does not occur. That is, in the injection molding, when the molded product is mass-produced by the calculated mold clamping force considered to be optimal, it is possible to reduce the risk of setting an inappropriate mold clamping force. Specifically, it is possible to realize support for gradually reducing the set mold clamping force by a certain amount and adjusting the set mold clamping force to the optimal mold clamping force.

In addition, the program according to the present embodiment may have the following configuration and can take various types of embodiments.

That is, the program according to the present embodiment is a program causing a control device 4 that controls a mold clamping unit 3 for clamping a mold 33 to execute control processing that includes a function of determining whether a second mold clamping force is appropriate, based on a change over time in the mold clamping force in a case where a set mold clamping force of the mold 33 is temporarily changed from a first mold clamping force to the second mold clamping force that is smaller than the first mold clamping force, and a function of, based on a determination result as to whether the second mold clamping force is appropriate, determining whether to change the set mold clamping force of the mold 33 from the first mold clamping force to the second mold clamping force, a mold clamping force between the first mold clamping force and the second mold clamping force, or a mold clamping force close to the second mold clamping force, or temporarily changing the set mold clamping force to a third mold clamping force that is smaller than the second mold clamping force.

Accordingly, whether to change the set mold clamping force to the set mold clamping force after the temporary change is determined based on whether the set mold clamping force after the temporary change is appropriate and on whether a quality defect of the molded product is present due to the set mold clamping force. As a result, even in a state where a non-defective product can be molded, it is possible to support the setting of the mold clamping force to be as small as possible within a range where the molding defect does not occur.

In addition, the injection molding machine 1 according to the present embodiment may have the following configuration and can take various types of embodiments.

That is, the injection molding machine 1 includes a control device 4 that controls the mold clamping unit 3 for clamping the mold 33, in which the control device 4 is configured to determine, based on a change over time in the mold clamping force in a case where a set mold clamping force of the mold 33 is temporarily changed from a first mold clamping force to a second mold clamping force that is smaller than the first mold clamping force, whether the second mold clamping force is appropriate, and determine, based on a determination result as to whether the second mold clamping force is appropriate, whether to change the set mold clamping force of the mold 33 from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

Accordingly, whether to change the set mold clamping force to the set mold clamping force after the temporary change is determined based on whether the set mold clamping force after the temporary change is appropriate. As a result, even in a state where a non-defective product can be molded, it is possible to support the setting of the mold clamping force to be as small as possible within a range where the molding defect does not occur.

Here, the control device 4 may determine that the second mold clamping force is appropriate in a case where the mold clamping force is temporarily increased and then returned to the set mold clamping force of the mold 33 as the change over time in the mold clamping force.

Accordingly, it is possible to determine whether the mold clamping force is appropriate based on the change over time in the mold clamping force.

In addition, the control device 4 may determine that the second mold clamping force is insufficient and is not appropriate in a case where the mold clamping force is increased and is not returned to the original mold clamping force as the change over time in the mold clamping force.

Accordingly, it is possible to determine whether the set mold clamping force is insufficient based on the change over time in the mold clamping force.

In addition, the control device 4 may determine that the second mold clamping force is excessive and is not appropriate in a case where the mold clamping force is constant as the change over time in the mold clamping force.

Accordingly, it is possible to determine whether the set mold clamping force is excessive based on the change over time in the mold clamping force.

In addition, an injection molding method according to the present embodiment may have the following configuration and can take various types of embodiments.

That is, the injection molding method according to the present embodiment is an injection molding method including causing a control device 4 that controls a mold clamping unit 3 for clamping a mold 33 to determine, based on a change over time in the mold clamping force in a case where a set mold clamping force of the mold 33 is temporarily changed from a first mold clamping force to a second mold clamping force that is smaller than the first mold clamping force, whether the second mold clamping force is appropriate, and determine, based on a determination result as to whether the second mold clamping force is appropriate, whether to change the set mold clamping force of the mold 33 from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

Accordingly, whether to change the set mold clamping force to the set mold clamping force after the temporary change is determined based on whether the set mold clamping force after the temporary change is appropriate. As a result, even in a state where a non-defective product can be molded, it is possible to support the setting of the mold clamping force to be as small as possible within a range where the molding defect does not occur.

In addition, the program according to the present embodiment may have the following configuration and can take various types of embodiments.

That is, the program according to the present embodiment is a program causing a control device 4 that controls a mold clamping unit 3 for clamping a mold 33 to execute control processing that includes a function of determining whether a second mold clamping force is appropriate, based on a change over time in the mold clamping force in a case where a set mold clamping force of the mold 33 is temporarily changed from a first mold clamping force to the second mold clamping force that is smaller than the first mold clamping force, and a function of, based on a determination result as to whether the second mold clamping force is appropriate, determining whether to change the set mold clamping force of the mold 33 from the first mold clamping force to the second mold clamping force, a mold clamping force between the first mold clamping force and the second mold clamping force, or a mold clamping force close to the second mold clamping force, or temporarily changing the set mold clamping force to a third mold clamping force that is smaller than the second mold clamping force.

Accordingly, whether to change the set mold clamping force to the set mold clamping force after the temporary change is determined based on whether the set mold clamping force after the temporary change is appropriate. As a result, even in a state where a non-defective product can be molded, it is possible to support the setting of the mold clamping force to be as small as possible within a range where the molding defect does not occur.

### Other

Although the present embodiment has been described above, the present invention is not limited to the above-described embodiments. Further, the effects of the present invention are also not limited to those described in the above-described embodiments. For example, the configuration of the injection molding machine 1 shown in FIG. 1 and the hardware configuration of the control device 4 shown in FIG. 3 are merely examples for achieving the object of the present invention, and are not particularly limited.

In addition, the functional configuration of the control device 4 shown in FIG. 4 is also merely an example, and is not particularly limited. It is sufficient that the injection molding machine 1 in FIG. 1 is provided with a function of executing the above-described processing as a whole, and the functional configuration to be used to realize this function is not limited to the example in FIG. 4. In addition, the order of the steps of the processing of the control device 4 shown in the flowchart of FIG. 5 is also merely an example, and is not particularly limited. The processing is not only performed in time series in accordance with the order of the shown steps, but also need not necessarily be performed in time series and may be performed in parallel or individually.

In addition, the specific example of the mold clamping force waveform shown in FIG. 2A, the specific example of the operation screen shown in FIG. 6, and the specific example of the popup screen shown in FIGS. 7A and 7B are merely examples for achieving the object of the present invention, and are not particularly limited.

It should be understood that the invention is not limited to the above-described embodiment, but may be modified into various forms on the basis of the spirit of the disclosure. Additionally, the modifications are included in the scope of the disclosure.

What is claimed is:

1. An injection molding machine comprising:
a control device that controls a mold clamping unit that clamps a mold,
wherein the control device is configured to
determine, based on an actual result obtained in a case where a set mold clamping force of the mold is temporarily changed from a first mold clamping force to a second mold clamping force that is smaller than the first mold clamping force, whether the second mold clamping force is appropriate,
receive an input indicating whether a quality defect of a molded product molded in a case where the set mold clamping force is temporarily changed to the second mold clamping force is present, and
determine, based on a determination result and an input result, whether to change the set mold clamping force from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

2. The injection molding machine according to claim 1,
wherein the control device is configured to determine not to change the set mold clamping force from the first mold clamping force, in a case where the input result indicates that the quality defect is present.

3. The injection molding machine according to claim 2,
wherein the input received by the control device is performed by an input operation of an operator on an operation screen.

4. The injection molding machine according to claim 1,
wherein the control device is configured to determine to change the set mold clamping force from the first mold clamping force to the second mold clamping force, the mold clamping force between the first mold clamping force and the second mold clamping force, or the mold clamping force close to the second mold clamping force, in a case where the determination result indicates that the second mold clamping force is appropriate and the input result indicates that the quality defect is not present.

5. The injection molding machine according to claim 4,
wherein, as the mold clamping force close to the second mold clamping force, the control device uses a mold clamping force including not only a value near the second mold clamping force but also the first mold clamping force set in the past, including the previous time, or the mold clamping force between the first mold clamping force and the second mold clamping force.

6. The injection molding machine according to claim 1,
wherein the control device is configured to determine to temporarily change the set mold clamping force from the second mold clamping force to the third mold clamping force that is smaller than the second mold clamping force, in a case where the determination result indicates that the second mold clamping force is not appropriate and the input result indicates that the quality defect is not present.

7. The injection molding machine according to claim 1,
wherein the control device includes a controller, a memory, a storage, an operation unit, and a display.

8. The injection molding machine according to claim 7,
wherein the controller includes a molding controller that controls injection molding, an acquisition unit that acquires information, a setting unit that performs settings, a determination unit that determines whether the set mold clamping force is appropriate, and a display controller that performs control to display information on the display.

9. The injection molding machine according to claim 8,
wherein the acquisition unit acquires input information input to an operation screen displayed on the display, and the input information includes a set mold clamping force value, information input to select an optimal mold clamping force determination mode, and information input to set a reduced mold clamping force.

10. The injection molding machine according to claim 9,
wherein the setting unit performs setting of the set mold clamping force and setting of the reduced mold clamping force, based on the input information acquired by the acquisition unit.

11. An injection molding method comprising:
causing a control device that controls a mold clamping unit that clamps a mold to
determine, based on an actual result obtained in a case where a set mold clamping force of the mold is temporarily changed from a first mold clamping force to a second mold clamping force that is smaller than the first mold clamping force, whether the second mold clamping force is appropriate,
receive an input indicating whether a quality defect of a molded product molded in a case where the set mold clamping force is temporarily changed to the second mold clamping force is present, and
determine, based on a determination result and an input result, whether to change the set mold clamping force from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

12. An injection molding machine comprising:
a control device that controls a mold clamping unit that clamps a mold,
wherein the control device is configured to
determine, based on a change over time in a mold clamping force when a set mold clamping force of the mold is temporarily changed from a first mold clamping force to a second mold clamping force that is smaller than the first mold clamping force, whether the second mold clamping force is appropriate, and
determine, based on a determination result, whether to change the set mold clamping force from the first mold clamping force to the second mold clamping force, a mold clamping force between the first mold clamping force and the second mold clamping force, or a mold clamping force close to the second mold clamping force, or temporarily change the set mold clamping force to a third mold clamping force that is smaller than the second mold clamping force.

13. The injection molding machine according to claim 12,
wherein the control device is configured to determine that the second mold clamping force is appropriate, in a case where, as the change over time in the mold clamping force, the mold clamping force temporarily increases and then returns to an original mold clamping force.

14. The injection molding machine according to claim 12,
wherein the control device is configured to determine that the second mold clamping force is insufficient and is not appropriate, in a case where, as the change over time in the mold clamping force, the mold clamping force increases and then does not return to an original mold clamping force.

15. The injection molding machine according to claim 12,
wherein the control device is configured to determine that the second mold clamping force is excessive and is not appropriate, in a case where, as the change over time in the mold clamping force, the mold clamping force is constant.
